(19) United States
(12) Patent Application Publication
(10) Pub. No.: US 2009/0132280 A1
(43) Pub. Date: May 21, 2009

(54) System and Method for a Worklist Search and Creation Tool in a Healthcare Environment

(75) Inventors: Mark Morita, Arlington Heights, IL (US); Prakash Mahesh, Hoffman Estates, IL (US); Murali Kariathungal, Hoffman Estates, IL (US); Christopher Janicki, Barrington, IL (US); Fahd Arshad, East Elmhurst, NY (US); Jason Cornwell, Mountain View, CA (US); Shaelyn Clements, Santa Monica, CA (US); David Knight, San Francisco, CA (US); Madhu Prabaker, San Francisco, CA (US); Nina Shih, San Marino, CA (US)

Correspondence Address: MCANDREWS HELD & MALLOY, LTD, 500 WEST MADISON STREET, SUITE 3400, CHICAGO, IL, 60661, US

(73) Assignee: General Electric Company, Schenectady, NY (US)

(21) Appl. No.: 11/943,982

(22) Filed: Nov. 21, 2007

(51) Int. Cl. G06F 17/30; H04L 9/32; G06Q 50/00

(52) U.S. Cl. 705/3; 707/3; 726/2; 705/2; 707/E17.014

(57) ABSTRACT

Certain embodiments of the present invention provide a system and method for a worklist search and creation tool in a healthcare environment. In an embodiment, the worklist search and creation system includes a worklist user interface, which includes an input search field adapted to receive inputted search data. The system also includes one or more databases for storing information that is associated with a data entry, which includes multiple fields of identification data. In addition, the system includes a search engine for searching the multiple fields of the data entry associated with the information stored in the one or more databases for identifying data that at least partially matches the inputted search data of the worklist user interface and displays any of the at least partially matching data entry in the worklist user interface.

### BACKGROUND OF THE INVENTION

The present invention generally relates to a worklist search and creation tool in a healthcare environment. In particular, certain embodiments of the present invention relate to a system and method for filtering, searching and/or querying multiple fields of a picture archiving and communication systems (PACS) worklist using a single, intelligent, live search field in a healthcare environment. Further, certain embodiments of the present invention relate to advanced searching functionality that has the ability to save custom worklists and is able to query disparate healthcare information systems.

A clinical or healthcare environment is a crowded, demanding environment. Thus, a system and method providing improved organization and improved ease of use of imaging systems, data storage systems, and other equipment used in the healthcare environment would be highly desirable. A healthcare environment, such as a hospital or clinic, encompasses a large array of professionals, patients, and equipment. Personnel in a healthcare facility must manage a plurality of patients, systems, and tasks to provide quality service to patients. Healthcare personnel may encounter many difficulties or obstacles in their workflow.

A variety of distractions in a clinical environment may frequently interrupt medical personnel or interfere with job performance. Furthermore, workspaces, such as a radiology workspace, may become cluttered with a variety of monitors, data input devices, data storage devices, and communication devices, for example. Cluttered workspaces may result in inefficient workflow and service to clients, which may impact a patient's health and safety or result in liability for a healthcare facility. Data entry and access is also complicated in a typical healthcare facility.

Thus, management of multiple and disparate devices, positioned within an already crowded environment, that are used to perform daily tasks is difficult for medical or healthcare personnel. Additionally, a lack of interoperability between the devices increases delay and inconvenience associated with the use of multiple devices in a healthcare workflow. The use of multiple devices may also involve managing multiple logons within the same environment. A system and method for improving ease of use and interoperability between multiple devices in a healthcare environment would be highly desirable.

In a healthcare environment involving extensive interaction with a plurality of devices, such as keyboards, computer mousing devices, imaging probes, and surgical equipment, repetitive motion disorders often occur. A system and method that eliminate some of the repetitive motion in order to minimize repetitive motion injuries would be highly desirable.

Healthcare environments, such as hospitals or clinics, include clinical information systems, such as hospital information systems (HIS) and radiology information systems (RIS), and storage systems, such as picture archiving and communication systems (PACS). Information stored may include patient medical histories, imaging data, test results, diagnosis information, management information, and/or scheduling information, for example. The information may be centrally stored or divided at a plurality of locations. Healthcare practitioners may desire to access patient information or other information at various points in a healthcare workflow. For example, during surgery, medical personnel may access patient information, such as images of a patient's anatomy, that are stored in a medical information system. Alternatively, medical personnel may enter new information, such as history, diagnostic, or treatment information, into a medical information system during an ongoing medical procedure.

In current information systems, such as PACS, information is entered or retrieved using a local computer terminal with a keyboard and/or mouse. During a medical procedure or at other times in a medical workflow, physical use of a keyboard, mouse or similar device may be impractical (e.g., in a different room) and/or unsanitary (i.e., a violation of the integrity of an individual's sterile field). Re-sterilizing after using a local computer terminal is often impractical for medical personnel in an operating room, for example, and may discourage medical personnel from accessing medical information systems. Thus, a system and method providing access to a medical information system without physical contact would be highly desirable to improve workflow and maintain a sterile field.

Imaging systems are complicated to configure and to operate. Often, healthcare personnel may be trying to obtain an image of a patient, reference or update patient records or diagnosis, and ordering additional tests or consultation. Thus, there is a need for a system and method that facilitate operation and interoperability of an imaging system and related devices by an operator.

In many situations, an operator of an imaging system may experience difficulty when scanning a patient or other object using an imaging system console. For example, using an imaging system, such as an ultrasound imaging system, for upper and lower extremity exams, compression exams, carotid exams, neo-natal head exams, and portable exams may be difficult with a typical system control console. An operator may not be able to physically reach both the console and a location to be scanned. Additionally, an operator may not be able to adjust a patient being scanned and operate the system at the console simultaneously. An operator may be unable to reach a telephone or a computer terminal to access information or order tests or consultation. Providing an additional operator or assistant to assist with examination may increase cost of the examination and may produce errors or unusable data due to miscommunication between the operator and the assistant. Thus, a method and system that facilitate operation of an imaging system and related services by an individual operator would be highly desirable.

A reading, such as a radiology or cardiology procedure reading, is a process of a healthcare practitioner, such as a radiologist or a cardiologist, viewing digital images of a patient. The practitioner performs a diagnosis based on a content of the diagnostic images and reports on results electronically (e.g., using dictation or otherwise) or on paper. The practitioner, such as a radiologist or cardiologist, typically uses other tools to perform diagnosis. Some examples of other tools are prior and related prior (historical) exams and their results, laboratory exams (such as blood work), allergies, pathology results, medication, alerts, document images, and other tools. For example, a radiologist or cardiologist typically looks into other systems such as laboratory information, electronic medical records, and healthcare information when reading examination results.

Currently, a practitioner must log on to different systems and search for a patient to retrieve information from the system on that patient. For example, if a patient complains of chest pain, a chest x-ray is taken. Then the radiologist logs on to other systems to search for the patient and look for specific conditions and symptoms for the patient. Thus, the radiologist may be presented with a large amount of information to review.

Depending upon vendors and systems used by a practitioner, practitioners, such as radiologists or cardiologists, have only a few options to reference the tools available. First, a request for information from the available tools may be made in paper form. Second, a practitioner may use different applications, such as a radiologist information system (RIS), picture archiving and communication system (PACS), electronic medical record (EMR), healthcare information system (HIS), and laboratory information system (LIS), to search for patients and examine the information electronically.

In the first case, the practitioner shifts his or her focus away from a reading workstation to search and browse through the paper, which in most cases includes many pieces of paper per patient. This slows down the practitioner and introduces a potential for errors due to the sheer volume of paper. Thus, a system and method that reduce the amount of paper being viewed and arranged by a practitioner would be highly desirable.

In the second case, electronic information systems often do not communicate well across different systems. Therefore, the practitioner must log on to each system separately and search for the patients and exams on each system. Such a tedious task results in significant delays and potential errors. Thus, a system and method that improve communication and interaction between multiple electronic information systems would be highly desirable.

Additionally, even if systems are integrated using mechanisms such as Clinical Context Object Workgroup (CCOW) to provide a practitioner with a uniform patient context in several systems, the practitioner is still provided with too much information to browse through. Too much information from different applications is provided at the same time and slows down the reading and analysis process. There is a need to filter out application components that a user will not need in a routine workflow. Thus, a system and method which manage information provided by multiple systems would be highly desirable.

Furthermore, if a technologist is performing a radiology or cardiology procedure, for example, the technologist typically accesses multiple applications to obtain information prior to the procedure. In a digital environment, information resides in a plurality of disparate systems, such as a RIS and a PACS. Currently, the technologist must access each system and search for the information by clicking many tabs and buttons before having access to all of the information needed to start the procedure. Often, such an effort by a technologist to obtain information for a procedure results in a decrease in productivity due to the time involve and/or a decrease in information quality due to the time involved to do a thorough search. Thus, a system and method which improve searchability and access to data would be highly desirable.

Additionally, referring physicians use many computerized applications for patient care. In radiology, a physician may look at information from RIS, PACS, EMR, and Computer Physician Order Entry (CPOE), for example. The referring physician typically accesses multiple applications to get all of the information needed before, during and/or after the patient consult and follow-up. For example, in a digital environment, the referring doctor refers to a RIS for results from a current procedure, prior procedures, and/or a web-based image viewer, such as a PACS, for viewing any current and prior images. The doctor may access a CPOE to order any follow-up exams. The referring physician opens the RIS, PACS, and CPOE to search for the information by clicking many tabs and buttons before having access to the information. Thus, there is a need for a system and method which improve searchability and access to data.

Furthermore, when performing searches using a worklist on a workstation, multiple filtering fields are used to filter and/or search specific types of patient information. For example, separate search fields are used to filter and/or search for a patient's name, a patient identification number, a procedure type, a modality and the date and/or time of a study, among other things. Thus, a system and method which improve searchability and access to data would be highly desirable.

Thus, there is a need for a system and method for filtering, searching and/or querying multiple fields of a picture archiving and communication systems (PACS) worklist using a single, intelligent, live search field in a healthcare environment. Further, there is a need for advanced searching functionality that has the ability to save custom worklists and is able to query disparate healthcare information systems.

### BRIEF SUMMARY OF THE INVENTION

Certain embodiments of the present invention provide a system and method for a worklist search and creation tool in a healthcare environment. In an embodiment, the worklist search and creation system includes a worklist user interface, which includes an input search field adapted to receive inputted search data. The system also includes one or more databases for storing information that is associated with a data entry, which includes multiple fields of identification data. In addition, the system includes a search engine for searching the multiple fields of the data entry associated with the information stored in the one or more databases for identifying data that at least partially matches the inputted search data of the worklist user interface and displays any of the at least partially matching data entry in the worklist user interface.

Certain embodiments of a method for searching and creating custom worklists include receiving inputted search data at an input search field of a worklist user interface. The method also includes searching multiple fields of a data entry associated with information stored in one or more databases for identifying data that at least partially matches the received inputted search data at the input search field of the worklist user interface. The method also includes displaying any at least partially matching data entry in the worklist user interface.

Certain embodiments of a computer-readable storage medium include a set of instructions for a computer. In certain embodiments, the set of instructions include a user action routine for receiving inputted search data at an input search field of a worklist user interface. The set of instructions also include a search engine routine for searching a multiple fields of a data entry associated with information stored in one or more databases for identifying data that at least partially matches the received inputted search data at the input search field of the worklist user interface. In addition, the set of instructions include a worklist routine for displaying any at least partially matching data entry in the worklist user interface.

### BRIEF DESCRIPTION OF SEVERAL VIEWS OF THE DRAWINGS

FIG. 1 illustrates a worklist search and creation system used in accordance with an embodiment of the present invention.

FIG. 2 illustrates a flow diagram for a method for searching and/or creating custom worklists in accordance with an embodiment of the present invention.

FIG. 3 illustrates a PACS worklist as is known in the art.

FIG. 4 illustrates an exemplary worklist with a single, intelligent, live text field in accordance with an embodiment of the present invention.

FIG. 5 illustrates an exemplary worklist with advanced search capability in accordance with an embodiment of the present invention.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF THE INVENTION

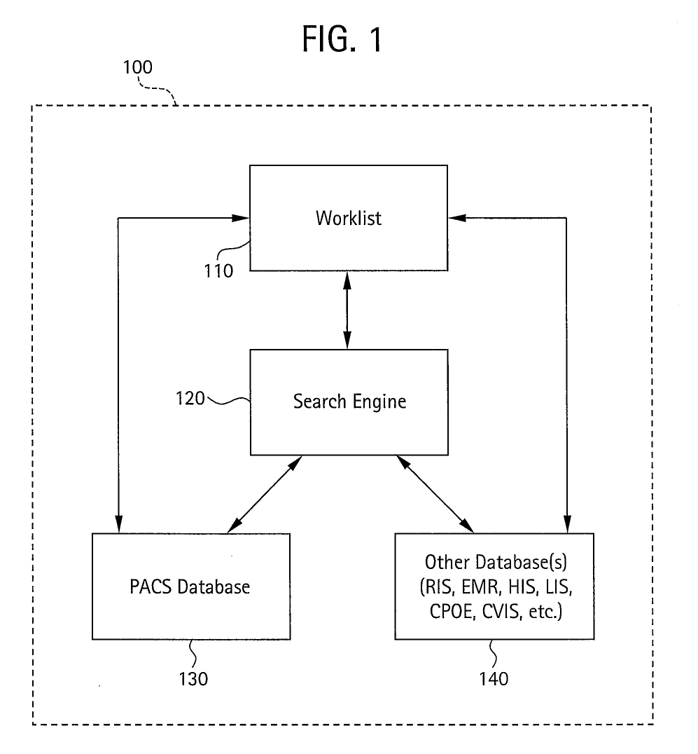

FIG. 1 illustrates a worklist search and creation system 100 used in accordance with an embodiment of the present invention. The system 100 includes a worklist user interface 110, a search engine 120 and at least one database 130, 140. Databases 130-140 may include a PACS database 130, a RIS database 140, a cardiovascular information system (CVIS) database 140, an EMR database 140, a HIS database 140, a LIS database 140, a CPOE database 140, or any other healthcare information system. The components of the system 100 may communicate via wired and/or wireless connections on one or more processing units, such as computers, medical systems, storage devices, custom processors, and/or other processing units. The system 100 may be implemented in software and/or hardware. In an embodiment, the worklist search and creation system 100 is able to communicate with external third party systems (not shown). In an embodiment, the components of the system 100 are integrated into a single unit, or may be integrated in various forms.

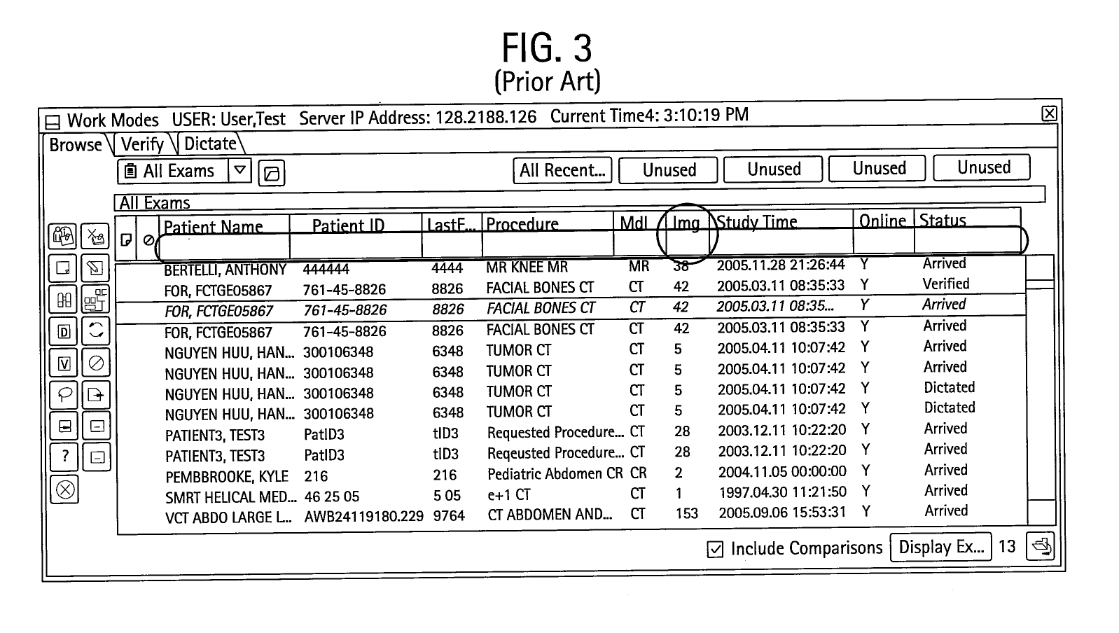

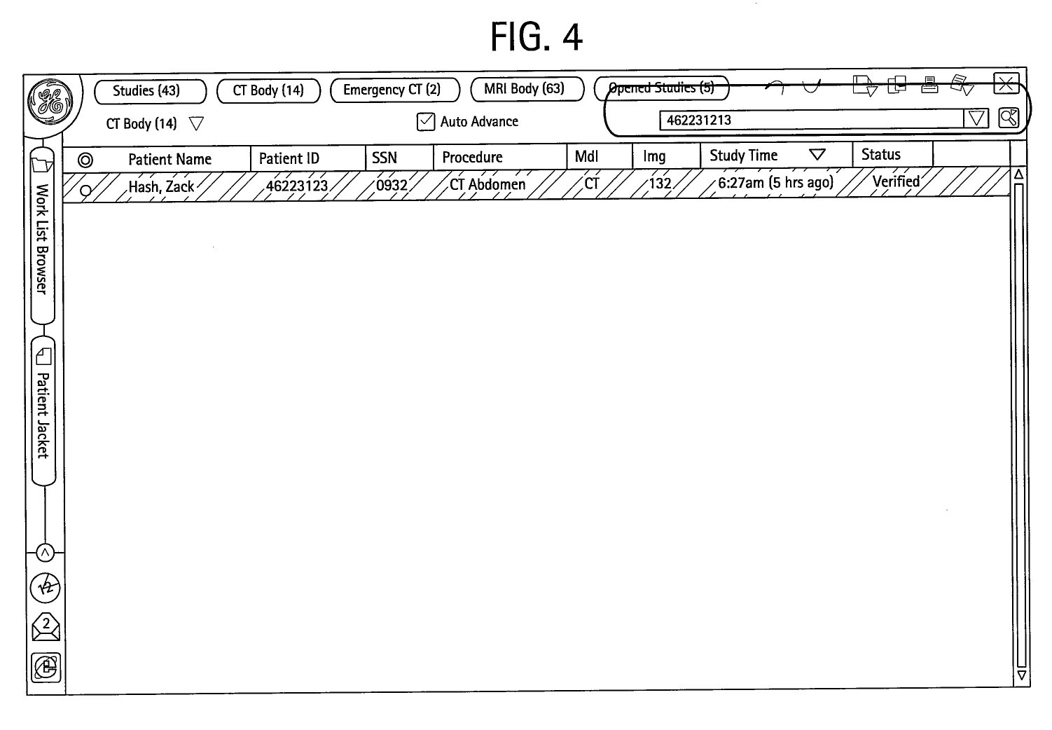

In an embodiment, the worklist 110 is a customizable user interface, such as a graphical or voice command user interface, which, among other things, allows a user to search, filter and/or query multiple worklist columns by using a single, intelligent, live text field. Examples of worklist columns may include columns for patient names, patient identification numbers, social security numbers, procedure types, modalities, number of images, study times and statuses, among other things. FIG. 3 illustrates an exemplary current PACS worklist having redundant filters or search fields under each column heading. The multiple search fields create unnecessary clutter on the user interface. FIG. 4 illustrates an exemplary worklist 110 having a single, intelligent, live text field for searching multiple columns to allow users the ability to more easily search and review patient information.

In an embodiment, the worklist 110 receives search data from a user in the single, intelligent, live text field and dynamically displays the filtered patient data entries that at least partially match the search data. A clinician, for example, using the system 100 may enter “C” into the single, intelligent, live, text field of worklist 110. The worklist 110 dynamically updates to display filtered patient data that at least partially matches “C”. For example, the worklist 110 may display patient names beginning with “C” (e.g., Charles and Crawford), procedures that begin with “C” (e.g., Chest, computed radiography (CR) abdomen and computed tomography (CT) pelvis) and/or modalities that begin with “C” (e.g., CT and CR), among other things. In an embodiment, as a user continues to enter search data, the worklist dynamically updates to display the further filtered patient data entries. Continuing the example above, after entering “C”, the clinician enters “R” into the single, intelligent, live, text field of worklist 110 and the worklist 110 may display patient names beginning with “CR” (e.g., Crawford), procedures that begin with “CR” (e.g., CR abdomen) and/or modalities that begin with “CR” (e.g., CR). The patient data entries displayed in worklist 110 may be further filtered as a user continues to enter search data into the single, intelligent, live text field of worklist 110.

In an embodiment, a user may enter multiple search data words into the single, intelligent, live search field of worklist 110. For example, if a clinician entered “Michaels CT” into the single, intelligent, live search field, the worklist 110 may display patient data entries containing the search data “Michaels CT.” Thus, in the above example, the worklist 110 may display any patient data entry with a patient name field containing “Michaels” and a procedure and/or modality field containing “CT.” Also, identifiers such as “AND” and “OR,” among other things, may be entered between the multiple search data words to define the search. As an example, if a clinician entered “Michaels AND CR OR CT” into the single, intelligent, live search field, the worklist 110 may display patient data entries containing “Michaels,” and “CT” or “CR.” In the above example, the worklist 110 may display any patient data entry with a patient name field containing “Michaels” and a procedure and/or modality field containing either “CT” or “CR.” In an embodiment, all fields of a patient data entry are displayed when one or more of the patient data entry fields contain the inputted search data.

In an embodiment, the worklist 110, at the direction of a user, may save the results of a search to memory. The memory may be associated with the worklist 110, the user workstation, the user network and/or the database(s) 130, 140, among other things. For example, after a clinician using the system 100 performs a search, the clinician may save the displayed patient data entries to memory so the search may be retrieved at a later time. The created custom worklist 110 may also allow a clinician to perform further searches on a smaller set of patient data entries. For example, after creating a custom worklist 110 containing patient data entries containing the search data “Smith,” a clinician can further filter the created custom worklist 110 to search for patient data entries containing the search data “tumor CT.” Thus, in the above example, the custom worklist 110 is already filtered to display patient data entries with a patient name field containing “Smith” and that previously filtered custom worklist 110 is further filtered to display patient data entries containing the search data “tumor CT.” A clinician, by creating and saving custom worklists, is able to increase productivity by allowing the clinician to retrieve previously created custom worklists without having to remember the search data used to obtain the filtered patient data entries.

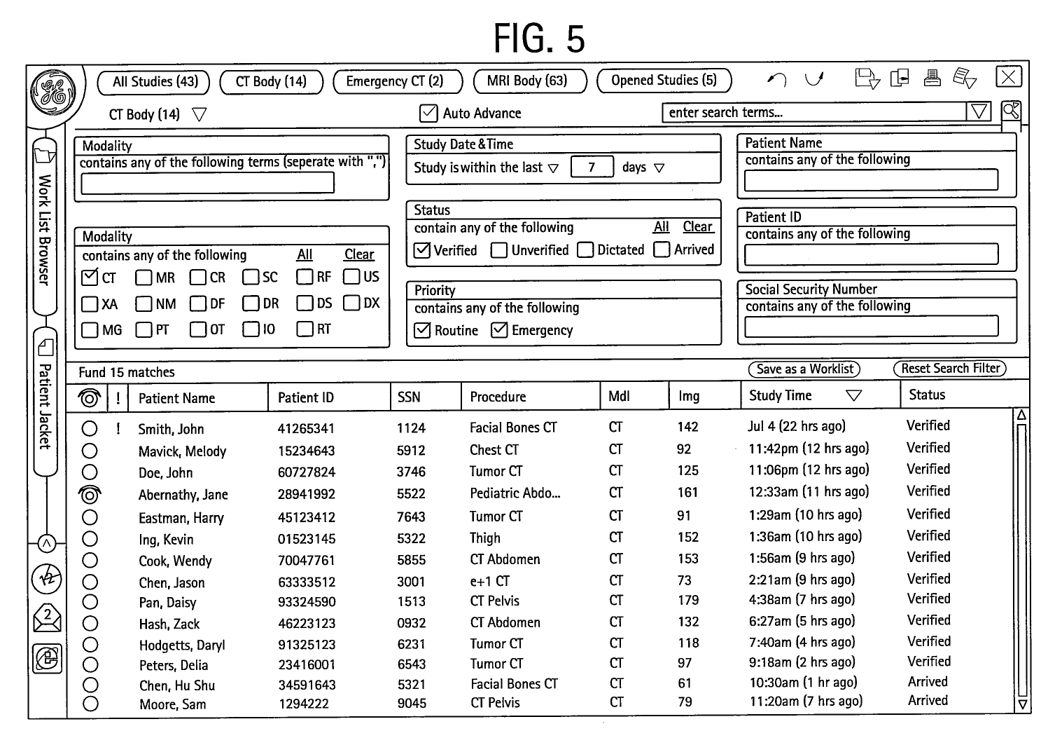

In an embodiment, the worklist 110 may have advanced searching capability. FIG. 5 illustrates an exemplary worklist with advanced search capability in accordance with an embodiment of the present invention. The advanced search feature of worklist 110 comprises search fields, check boxes and/or drop down menus, among other things. The advanced search feature of worklist 110 may allow users to simultaneously search multiple fields of patient data entries using a variety of commonly used search parameters. The advanced search feature of worklist 110 may allow a user to save customized searches as custom worklists. The advanced search feature of worklist 110 may allow a user to search disparate healthcare information systems for relevant clinical information to support the diagnostic process. For example, a clinician using the advanced search feature of worklist 110 may enter search data into a procedure search field, patient name search field, patient ID search field and/or social security number search field, among other things. Further, a clinician using the advanced search feature of worklist 110 may check one or more boxes representing one or more modalities, statuses and/or priorities, for example, to search. A clinician using the advanced search feature of worklist 110 may also search for studies occurring within a period of time, among other things. The clinician, by utilizing the dynamically updating worklist 110, is able to increase productivity by efficiently locating patient data entries relevant to the clinician's advanced search data.

In an embodiment, a search engine 120 searches and filters the data collected from the database(s) 130, 140 and displays the information on the worklist 110. The search engine 120 uses the search data inputted into the single, intelligent, live, text field of worklist 110 to search and retrieve patient data entries from database(s) 130, 140 to display in worklist 110. Additionally or alternatively, the search engine 120 uses the search data inputted into the advanced search feature of worklist 110 to search and retrieve patient data entries from database(s) 130, 140. For example, as a clinician enters search data into the single, intelligent, live, text field of worklist 110, the search engine 120 dynamically updates the worklist 110 by dynamically searching and filtering the patient information available in the databases 130, 140. The clinician, by utilizing the dynamically updating worklist 110, is able to increase productivity by efficiently locating patient data entries relevant to the clinician's search data.

In an embodiment, the information contained in a database 130, 140 may be department specific information and/or enterprise information, among other things. For example, in a medical environment, enterprise information may be hospital records (i.e. insurance information, scheduled exams, etc) and electronic medical records (EMR). The information contained in a data store may also be department specific information. For example, in a medical environment, department specific information may be archived examination images (e.g., PACS), prior and related prior (historical) exams and results, laboratory exams (such as blood work), allergies, pathology results, medication, alerts, and document images. Examples of various department specific and/or enterprise information may be found in a PACS database, RIS database, CVIS database, EMR database, HIS database, LIS database, CPOE database, and the like. Information in the database(s) 130, 140 may be accessed through the worklist 110 if the information is linked to the worklist 110 via the patient data entries or it may be accessed separately through other applications. For example, after search engine 120 retrieves patient data entries from database(s) 130, 140 using the search data inputted into the single, intelligent, live text field of worklist 110 and displays the filtered patient data entries on worklist 110, a user may access the patient information associated with the patient data entries by selecting the particular patient data entry of interest. In an embodiment, the worklist 110 may then retrieve from database(s) 130, 140 the selected patient data information and display the information (e.g., PACS images, electronic medical records, prior and related prior exams and results, etc.) using worklist 110 or a separate application.

In an embodiment, the worklist 110 includes and/or communicates with an authentication unit. The authentication unit may include software and/or hardware to verify a user's right to access one or more of the databases 130, 140. In an embodiment, authentication via the worklist 110 allows access to relevant databases 130, 140 and other applications for a user. For example, if a user logs on to a system running the worklist 110, the system 100 may allow immediate access information from database(s) 130, 140 depending on user and/or system manager settings.

In operation, a user, such as a radiologist or cardiologist, accesses the system 100 via worklist 110. Automatic login to one or more systems/applications/databases may be accomplished depending on user and/or system manager settings. The user enters search data into one or more of the single, intelligent, live text field and the advanced search feature of worklist 110. The search engine 120 searches, filters and/or queries database(s) 130, 140 to obtain relevant patient data entries and displays the relevant patient data entries on worklist 110. A user may then save the search as a custom worklist and/or select a patient data entry to retrieve additional information associated with the patient data entry from database(s), among other things.

Examples of non-medical environment applications include, but are not limited to: a test engineer may use the system 100 in searching product tests; an accountant may use the system 100 in searching financial planning or tax information for their customers, and; an attorney may use the system 100 in searching client case information. In each of the above examples, a user inputs search data into the single, intelligent, live text field (or advanced search feature) of worklist 110 and search engine 120 searches, filters and/or queries database(s) 130, 140 to obtain relevant client data entries to display on worklist 110. A user may then access information related to the client data entries by selecting the client data entry of interest. Worklist 110 may then retrieve from database(s) 130, 140 the selected client data information and display the information using worklist 110 or a separate application.

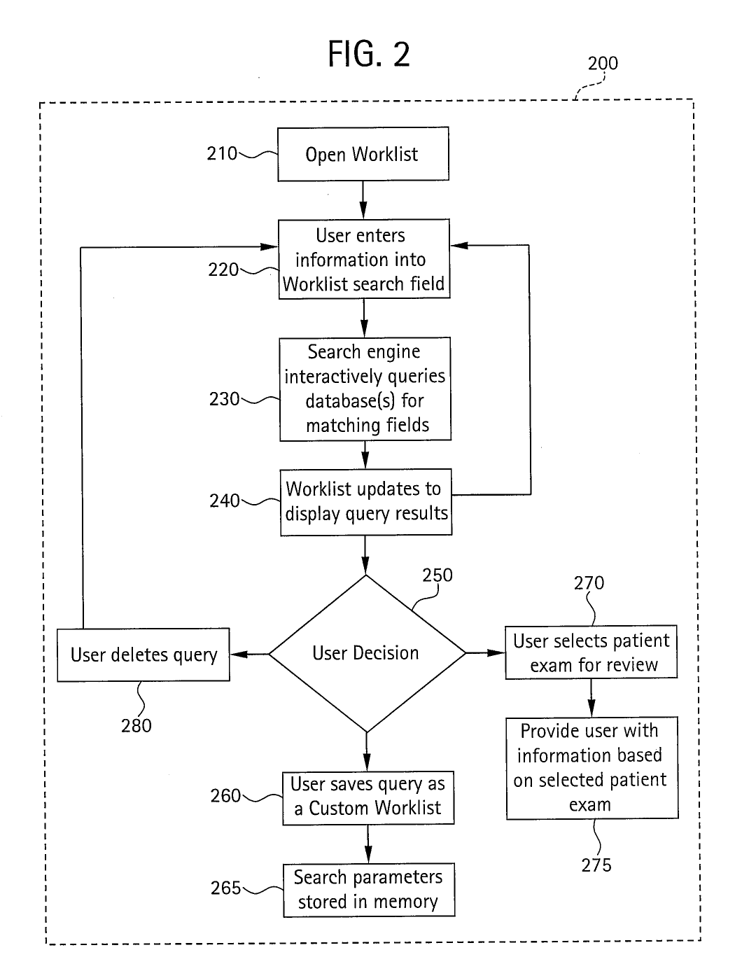

FIG. 2 illustrates a flow diagram for a method 200 for searching and/or creating custom worklists in accordance with an embodiment of the present invention.

First, at step 210, a user logs in to system 100 and/or opens worklist 110. By opening worklist 110 and/or logging on to the system 100, a user may be allowed immediate access to information from database(s) 130, 140. When opening and/or logging on to the system 100, the worklist 110 may include and/or communicate with an authentication unit. The authentication unit may include software and/or hardware to verify a user's right to access one or more of the databases 130, 140. In an embodiment, authentication via the worklist 110 allows access to relevant databases 130, 140 and other applications for a user. For example, if a user logs on to a system running the worklist 110, the system 100 may allow immediate access of information from database(s) 130, 140 depending on user and/or system manager settings.

At step 220, a user inputs search data into the single, intelligent, live text field and/or the advanced search feature of worklist 110. The single, intelligent, live text field and/or the advanced search feature of worklist 110 allows a user to search, filter and/or query multiple worklist columns. Examples of worklist columns may include columns for patient names, patient identification numbers, social security numbers, procedure types, modalities, number of images, study times and statuses, among other things. FIG. 3 illustrates an exemplary current PACS worklist having redundant filters or search fields under each column heading. The multiple search fields create unnecessary clutter on the user interface. FIG. 4 illustrates an exemplary worklist 110 having a single, intelligent, live text field for searching multiple columns to allow users the ability to more easily search and review patient information. FIG. 5 illustrates an exemplary worklist 110 having advanced search capability for searching specific patient information, procedure information, modality information and the like, to allow users the ability to more easily search and review patient information.

Then, at step 230, patient data entries relevant to the search data inputted into worklist 110 are obtained using a search engine 120 to search, filter and/or query database(s) 130, 140. The search engine 120 uses the search data inputted into the single, intelligent, live, text field of worklist 110 to search and retrieve relevant patient data entries from database(s) 130, 140. For example, a clinician may enter one or more characters of search data, a search data word or number, multiple search words or numbers, and the like. The inputted search data may be separated by identifiers such as “AND” and/or “OR,” for example. Additionally or alternatively, the search engine 120 uses the search data inputted into the advanced search feature of worklist 110 to search and retrieve patient data entries from database(s) 130, 140. For example, a clinician using the advanced search feature of worklist 110 may enter search data into a procedure search field, patient name search field, patient ID search field and/or social security number search field, among other things. Further, a clinician using the advanced search feature of worklist 110 may check one or more boxes representing one or more modalities, statuses and/or priorities, for example, to search. A clinician using the advanced search feature of worklist 110 may also search for studies occurring within a period of time, among other things.

Next, at step 240, the relevant information filtered by the search engine 120 is displayed on the worklist 110. Steps 220-240 are a dynamic process. For example, with every character inputted into the single, intelligent, live text field of worklist 110, search engine 120 interactively queries database(s) 130, 140 for relevant patient data entries and displays the relevant patient data entries in worklist 110.

At step 250, a user may decide to save the patient data entries as a custom worklist, select one or more patient data entries for review and/or clear the patient data entries and reset the worklist to perform a new search, among other things.

At steps 260-265, a user may decide to save the patient data entries as a custom worklist. The custom worklist created by the user may be saved in memory. The memory may be associated with the worklist 110, the user workstation, the user network and/or the database(s) 130, 140, among other things. For example, after a clinician using the system 100 performs a search, the clinician may save the displayed patient data entries to memory so the search may be retrieved at a later time. A clinician, by creating and saving custom worklists, is able to increase productivity by allowing the clinician to retrieve previously created custom worklists without having to remember the search data used to obtain the filtered patient data entries.

At steps 270-275, a user may decide to review the information related to a specific patient data entry, a patient data entry may be selected by a user. Information in the database(s) 130, 140 may be accessed through the worklist 110 if the information is linked to the worklist 110 via the patient data entries or it may be accessed separately through other applications. For example, after search engine 120 retrieves patient data entries from database(s) 130, 140 using the search data inputted into the single, intelligent, live text field of worklist 110 and displays the filtered patient data entries on worklist 110, a user may access the patient information associated with the patient data entries by selecting the particular patient data entry of interest. In an embodiment, the worklist 110 may then retrieve from database(s) 130, 140 the selected patient data information and display the information (e.g., PACS images, electronic medical records, prior and related prior exams and results, etc.) using worklist 110 or a separate application.

At step 280, a user may decide to clear the patient data entries of a previous search and reset worklist 110 so a user may perform a new search.

Thus, certain embodiments search, query and/or filter information available to a user based on search data inputted into a single, intelligent, live text field or advanced search module. Certain embodiments unify a variety of departmental and enterprise information for a user to search, display and access. Certain embodiments allow a user to save customized worklists based on completed searches. Certain embodiments facilitate increased productivity of a radiologist, cardiologist, or other users whose workflow include searching and accessing relevant departmental and enterprise information. Increased productivity includes a speed in which a diagnosis may be performed and an accuracy of reports produced based on the diagnosis.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A worklist search and creation system, the system comprising:
a worklist user interface, wherein the worklist user interface comprises an input search field adapted to receive inputted search data;
at least one database adapted to store a plurality of information, wherein each of the plurality of information is associated with a data entry comprising a plurality of fields of identifying data; and
a search engine adapted to search the plurality of fields of the data entry associated with each of the plurality of information stored in the at least one database for identifying data that at least partially matches inputted search data of the worklist user interface and to display any at least partially matching data entry in the worklist user interface.

2. The system of claim 1, further comprising a memory adapted to store any at least partially matching data entry displayed in the worklist user interface.

3. The system of claim 1, further comprising an advanced search module comprising at least one of:
at least one text search field,
at least one checkbox search field, and
at least one drop down menu search field.

4. The system of claim 1, wherein the worklist user interface is adapted to access at least one external system.

5. The system of claim 1, wherein the at least one database comprises at least one of:
a picture archiving and communication system (PACS),
a radiology information system (RIS),
a cardiovascular information system (CVIS),
an electronic medical records (EMR),
a hospital information system (HIS),
a laboratory information system (LIS), and
a computer physician order entry (CPOE).

6. The system of claim 1, wherein the data entry is a medical patient data entry.

7. The system of claim 6, wherein the plurality of fields comprises a plurality of:
a patient name,
a patient identification number,
at least part of a social security number,
a procedure type,
a modality,
a number of images,
a study date and/or time, and
a status.

8. The system of claim 1, further comprising an authentication module for authenticating access to the worklist user interface and/or the at least one database.

9. A method for searching and creating custom worklists, the method comprising:
receiving inputted search data at an input search field of a worklist user interface;
searching a plurality of fields of a data entry associated with each of a plurality of information stored in at least one database for identifying data that at least partially matches the received inputted search data at the input search field of the worklist user interface; and
displaying any at least partially matching data entry in the worklist user interface.

10. The method of claim 9, further comprising authenticating access to the plurality of information stored in the at least one database.

11. The method of claim 9, further comprising selecting one of the any at least partially matching data entry in the worklist user interface.

12. The method of claim 11, further comprising accessing the plurality of information associated with the selected one of the any at least partially matching data entry.

13. The method of claim 9, further comprising storing in a memory the displayed any at least partially matching data entry.

14. The method of claim 9, wherein the process of searching and displaying is dynamic as the inputted search data is received at the input search field of the worklist user interface.

15. The method of claim 9, wherein the at least one database comprises at least one of:
a picture archiving and communication system (PACS),
a radiology information system (RIS),
a cardiovascular information system (CVIS),
an electronic medical records (EMR),
a hospital information system (HIS),
a laboratory information system (LIS), and
a computer physician order entry (CPOE).

16. The method of claim 9, wherein the data entry is a medical patient data entry.

17. The method of claim 16, wherein the plurality of fields comprises a plurality of:
a patient name,
a patient identification number,
at least part of a social security number,
a procedure type,
a modality,
a number of images,
a study date and/or time, and
a status.

18. A computer-readable storage medium including a set of instructions for a computer, the set of instructions comprising:
a user action routine for receiving inputted search data at an input search field of a worklist user interface;
a search engine routine for searching a plurality of fields of a data entry associated with each of a plurality of information stored in at least one database for identifying data that at least partially matches the received inputted search data at the input search field of the worklist user interface; and
a worklist routine for displaying any at least partially matching data entry in the worklist user interface.

19. The set of instructions of claim 18, further comprising a user selection routine for accessing the plurality of information associated with a user selected one of the any at least partially matching data entry.

20. The set of instructions of claim 18, further comprising a user customized worklist creation routine for storing in a memory the displayed any at least partially matching data entry.
